(19) United States
(12) Patent Application Publication
(10) Pub. No.: US 2014/0210632 A1
(43) Pub. Date: Jul. 31, 2014

(54) AMPLITUDE AND FREQUENCY-BASED DETERMINATION

(71) Applicant: HEWLETT-PACKARD DEVELOPMENT COMPANY, L.P., (US)

(72) Inventors: Choudur LAKSHMINARAYAN, Austin, TX (US); Vivek BOOMINATHAN, Houston, TX (US); D. Shyama PURNIMA, Hyderabad (IN)

(73) Assignee: HEWLETT-PACKARD DEVELOPMENT COMPANY, L.P., Houston, TX (US)

(21) Appl. No.: 13/755,051

(22) Filed: Jan. 31, 2013

(51) Int. Cl. G01D 21/00

(52) U.S. Cl. CPC G01D 21/00
USPC 340/853.2

(57) ABSTRACT

A method includes computing, by an amplitude feature computation engine, an amplitude feature of a frame of time-series data. The method further includes computing, by a frequency feature computation engine, a frequency feature of the frame of time-series data.

### BACKGROUND

Many systems are instrumented with various types of sensors. Such sensors provide signals that can be analyzed to detect problems with the operation of the system. For example, oil and gas wells may have flow sensors that indicate the rate of flow in the well at the location of the sensors. Detection of, and response to, an erroneous condition may help avoid a serious problem.

### BRIEF DESCRIPTION OF THE DRAWINGS

For a detailed description of various examples, reference will now be made to the accompanying drawings in which:

FIG. 1 shows an example of a time and frequency-based regime determination system;

FIG. 2 shows an example of a method for computing bivariate vectors;

FIG. 3 shows an example of a system to generate the bivariate vectors;

FIG. 4 shows another example of a system to generate the bivariate vectors;

FIG. 5 shows an example of a method to compute an amplitude feature of a bivariate vector;

FIG. 6 shows an example of a method to compute a frequency feature of a bivariate vector;

FIG. 7 shows an example of a system to classify live data;

FIG. 8 shows an example of a method to classify live data; and

FIG. 9 shows another example of a method to classify live data.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct connection or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Many types of data have an oscillatory pattern that is normal (i.e., indicative of problem-free behavior). Such data is referred to herein as normal oscillation (NO) data. However, during various types of problem conditions, the data may become characteristic of high amplitude oscillation (HAO) or low amplitude oscillation (LAO). Data that is HAO or LAO may be indicative of various problems that can be addressed and resolved if detected in time. HAO and LAO data may have a frequency that is similar, but higher than that of NO data. HAO data may be characterized by amplitude swings that are greater than that of NO and LAO data, while the amplitude swings for LAO data may be less than that of NO and HAO data. Each of the NO, LAO and HAO data are referred to as a “regime.” The disclosed technique classifies data as NO, LAO, or HAO regime data, but the technique is applicable as well to data classification for other than a three-regime application.

An example of a system that has NO type data during normal system operation, but may become HAO or LAO during abnormal system operation is an oil/gas well. The data may be generated by flow rate sensors that are provided along the drill string. Each flow rate sensor generates a signal indicative of the rate of flow of the produced material (oil, gas). During normal well operation, the rate of flow may increase and decrease over time and at a normal level of oscillation. During certain problem conditions, the flow rate may become HAO or LAO in nature. Another example of a system that may have NO, LAO and HAO tendencies is an electrocardiogram (ECG) of a patient.

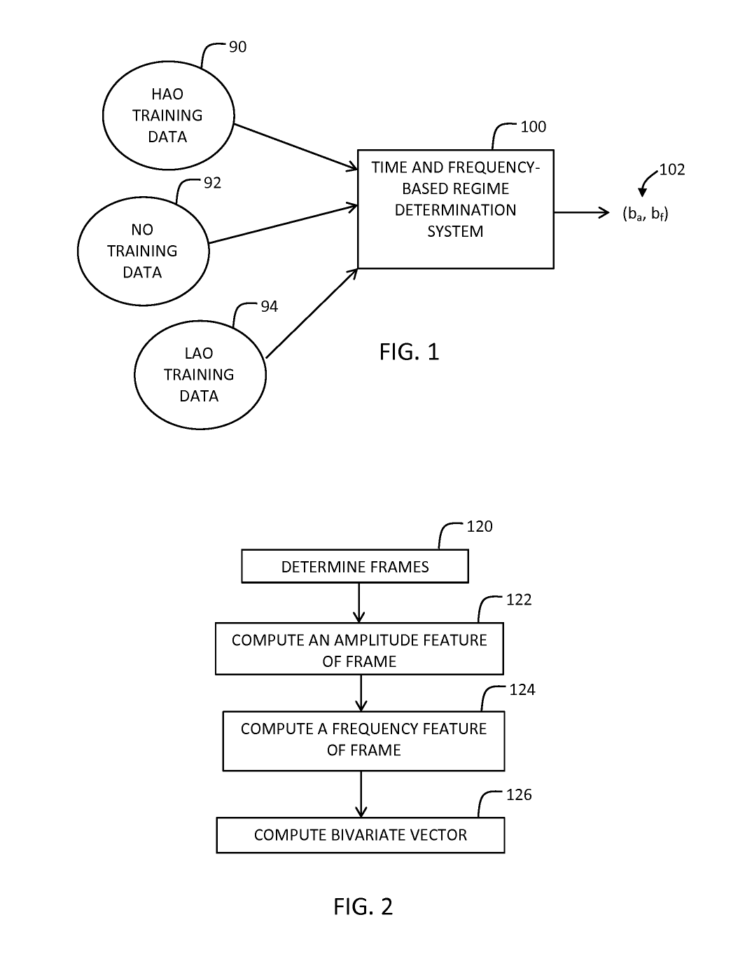

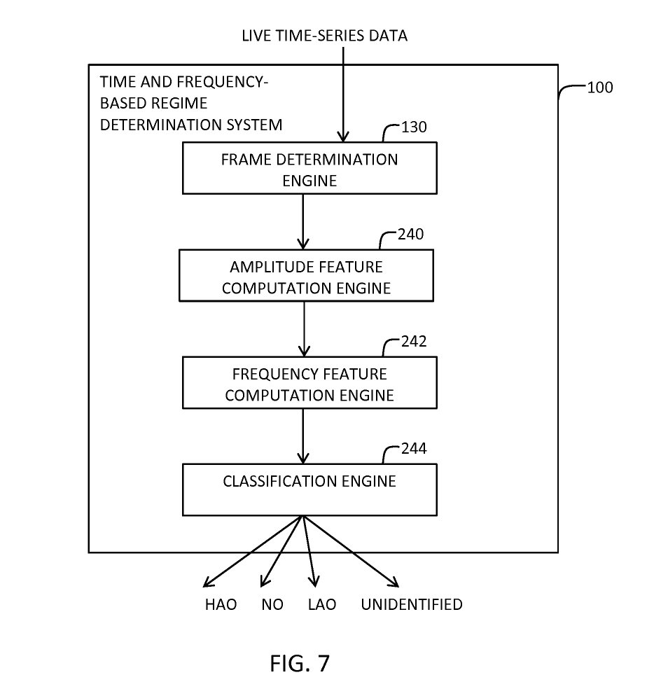

The disclosed technique involves processing of NO, LAO and HAO training data to generate a bivariate vector characteristic of each of the NO, LAO and HAO regimes. The bivariate vectors them may be used to classify “live” data as the NO, LAO, or HAO regime. Live data comprises data that is not training data for which classification is desired into one of the regimes. FIGS. 1-6 below are used to illustrate an implementation of the training process to generate suitable bivariate vectors, while FIG. 7-10 illustrate the use of the bivariate vectors to classify live data.

FIG. 1 illustrates a time and frequency-based regime determination system 100 that receives training data 90, 92, and 94. Training data 90 includes data which is known apriori to be characteristic of HAO data, and is referred to as HAO training data. Training data 92 is characteristic of NO data (NO training data) and training data 94 is characteristic of LAO data (LAO training data). In at least some implementations, the time and frequency-based regime determination system 100 receives each set of training data 90-94, one at a time, and processes the training data to produce a bivariate vector 102 indicative of that training data. The bivariate vector 102 includes an amplitude feature, b_{A}, and a frequency feature, b_{f}. As such, an amplitude feature and a frequency feature are computed for each set of training data. The bivariate vectors are unique to each regime and thus can be used to classify live data into one of the regimes. The process for extracting the amplitude and frequency features from the training data is described below with respect to FIG. 2.

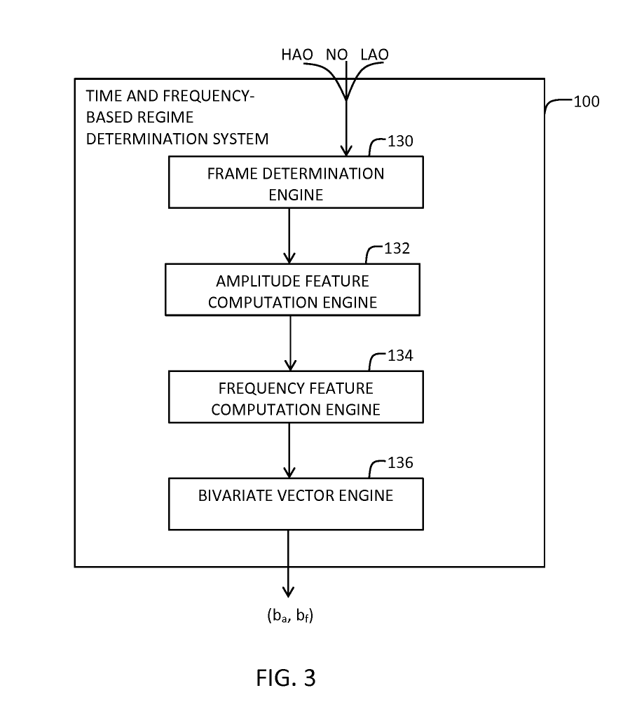

FIG. 2 illustrates a method for generating the bivariate vector for each set of training data. The method of FIG. 2 may be performed for each set of training data. FIG. 3 illustrates an implementation of the time and frequency-based regime determination system 100, which is suitable for performing the method of FIG. 2. The illustrative implementation of system 100 includes a frame determination engine 130, an amplitude feature computation engine 132, a frequency feature computation engine 134, and a bivariate vector engine 136.

The system 100 may be a standalone system or may be part of an integrated package. For example, system 100 may be a component of a data analytics system. Such a data analytics system may include various functionality. For example, the data analytics system may include a clustering engine to cluster various types of data, such as customer comments and reviews. As another example, the data analytics system may include a speech analysis engine to perform speech recognition. In some examples, the functionality of system 100 may be integrated with other functionality of the data analytics system to perform additional analysis.

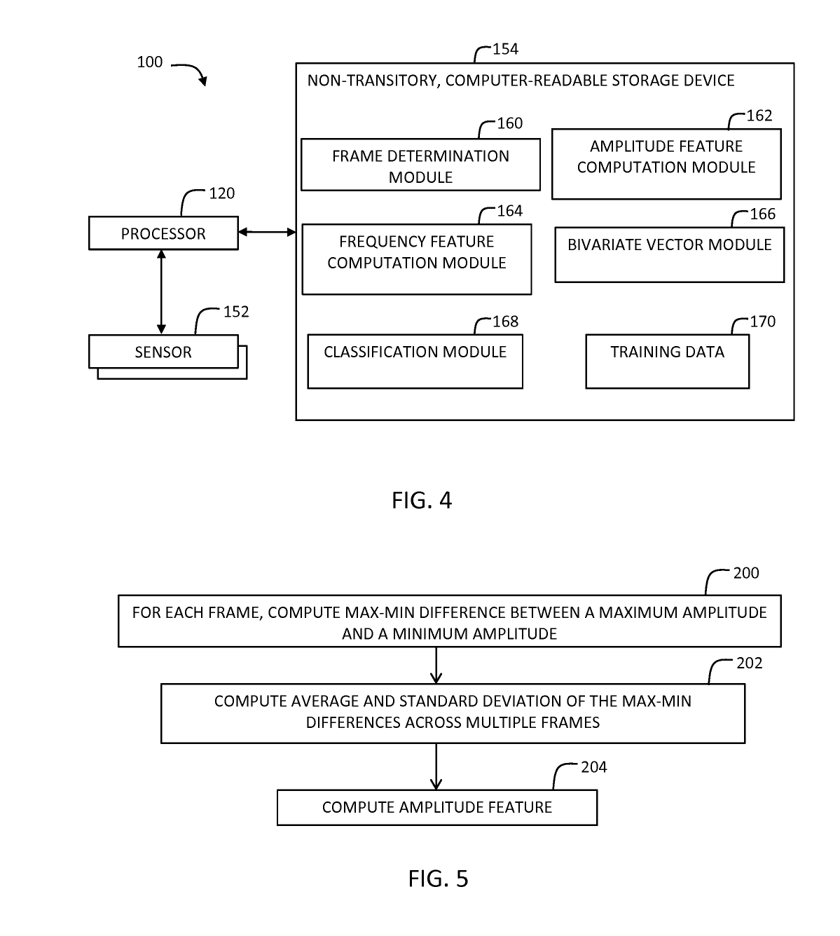

FIG. 4 illustrates another implementation of the time and frequency-based regime determination system 100 as including a processor 150 coupled to one or more sensors 152 and a non-transitory, computer-readable storage device 154. The sensors 152 may be flow rate sensors or other types of sensors. The non-transitory, computer-readable storage device 154 may include volatile storage (e.g., random access memory), non-volatile storage (e.g., hard disk drive, Flash storage, optical disc, etc.) or combinations of both volatile and non-volatile storage. The non-transitory, computer-readable storage device 154 includes a frame determination module 160, an amplitude computation module 162, a frequency computation module 164, a bivariate vector module 166, a classification module 168, and training data 170. Each of the modules 160-168 may comprise software that is executable by the processor 150 to perform any or all of the operations depicted in the method of FIG. 2. The various engines 130-136 may be implemented as processor 150 executing the corresponding module 160-166. For example, the frame determination engine 130 may be implemented as the processor 150 executing frame determination module 160.

A classification engine is used for classification of live data, not during the training process, and thus is not shown in FIG. 2. However, a classification engine 244 is shown in FIG. 7 which will be discussed below regarding the classification process. The classification engine 244 may be implemented as the processor 150 executing the classification module 168.

Any references herein to the operation performed by a particular engine should be understood, in at least some implementations, to be performed by the processor 150 executing the corresponding module.

Referring back to FIGS. 2 and 3, at 120, the training data for a given regime is time series data and is divided into frames of samples (e.g., 30 samples per frame) by the frame determination engine 130. The number of samples per frame depends on the rate at which the training data was collected or otherwise generated. The size of each frame can be determined from performing the method of FIG. 2 multiple times for different frame sizes, and analyzing the results to determine the optimal frame size given the data at hand being analyzed—different types of data may result in a different optimal frame size. Each frame of data may overlap the preceding frame of data. That is, at least one data value in one frame may be part of an adjacent frame as well. The number of samples of overlap is based on how fast the system evolves into the various regimes. Systems that so evolve more quickly should have a larger amount of overlap than more slowly evolving systems. Further, a larger degree of overlap will result in more pre-processing time required, and thus the amount of overlap may also be chosen based on the amount of pre-processing time permitted.

Once the frames are determined, the amplitude feature for each frame is computed at 122 by the amplitude feature computation engine 132. The process for computing the amplitude feature is illustrated in FIG. 5. To compute the amplitude feature, amplitude feature computation engine 132 computes the difference between the maximum and the minimum amplitude values of the samples within each frame (200, FIG. 5). The set of amplitude differences across the frames then is averaged at 202 to obtain a mean (μ) and a standard deviation (σ). At 204, the amplitude feature is computed for each set of training data. For the HAO training data, the amplitude feature is computed as the mean minus the standard deviation (μ−σ) which represents the lower threshold of the amplitude range. For the LAO training data, the amplitude feature is computed as the mean plus the standard deviation (μ+σ) which represents the upper threshold of the amplitude range. Similarly, for the NO training data, amplitude feature also is computed as the mean plus the standard deviation (μ+σ) which represents the upper threshold of the amplitude range. Because the data among the various training data sets are different, the mean and standard deviations also are different from one regime to another.

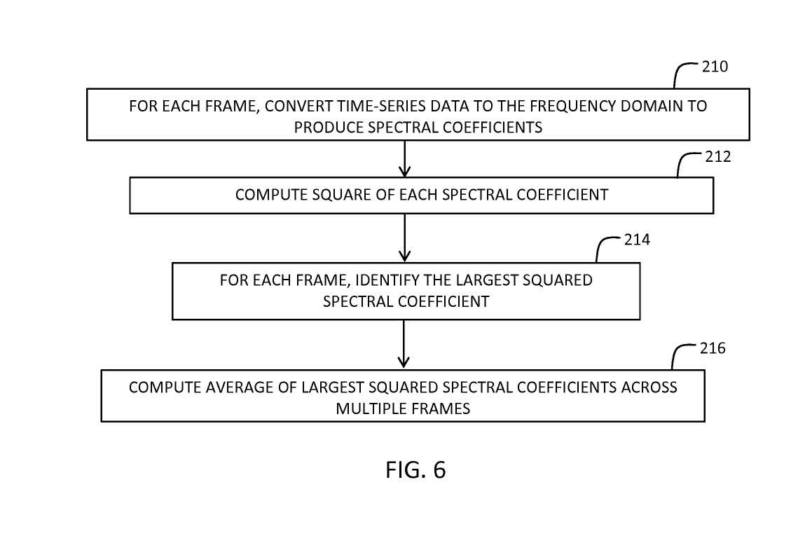

At 124 (FIG. 2), the method includes computing the frequency feature of the frame. This operation is performed by the frequency feature computation engine 134 (FIG. 3) and is further detailed in FIG. 6. At 210, for each frame, the time series data is converted to the frequency domain to produce spectral coefficients. In at least some implementations, the conversion from the time domain to the frequency domain is performed using a Fast Fourier Transform computation. At 212, the square of each spectral coefficient is computed, and at 214, the largest squared spectral coefficient is identified. At 216, the method includes computing an average of the largest squared spectral coefficient across the various frames. Each spectral coefficient within a frame may be designated as cₖ, k=1, 2, . . . n_{f}, where n_{f} is the number of samples in the frame. The square of the spectral coefficients thus is cₖ². The average largest squared spectral coefficient is designated herein as c̅_{f} and is computed as

$${\overline{c}}_{f} = \frac{1}{N} {\sum }_{k = 1}^{N} ( max ( {c}_{k}^{2} ) ) ,$$

where N is the number of frames.

The bivariate vector for each of the various regimes is provided below in Table I. The mean, standard deviation, and c̅_{f} values are computed for each of the corresponding sets of training data as described above. Thus, μ, σ, c̅_{f} for the HAO regime is a different value than μ, σ, c̅_{f} for the LAO and NO regimes.

TABLE I
Bivariate Vectors for Each Regime

Bivariate Vector

| Regime | Amplitude Feature (bₐ) | Frequency Feature (b_{f}) |
|---|---|---|
| HAO | μ − σ | c̅_{f} |
| LAO | μ + σ | c̅_{f} |
| NO | μ + σ | c̅_{f} |

Once the bivariate vector for each regime is computed, the vectors can be used to classify live data. The classification process may be performed in real time to detect the occurrence of a problem as it is occurring.

FIG. 7 provides another implementation of the time and frequency-based regime determination system 100. In FIG. 7, the system 100 includes a frame determination engine 130, an amplitude feature computation engine 240, a frequency feature computation engine 242, and a classification engine 244. The engines 130, 240, 242, and 244 may be implemented as the processor 150 executing a corresponding software module.

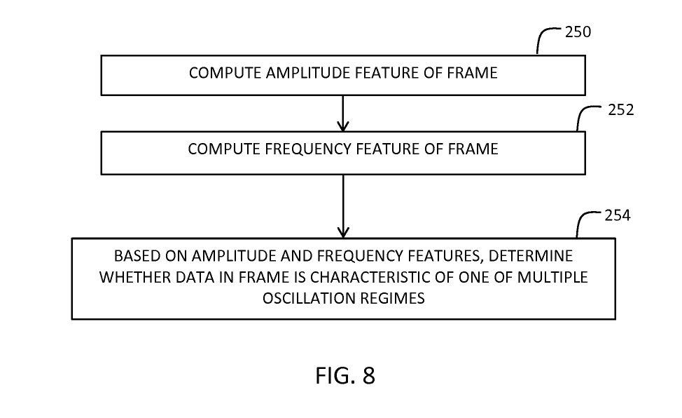

To classify live data, the method of FIG. 8 may be performed. The classification may be performed on a frame by frame basis, with the data of each frame attempted to be classified into one of the various regimes (e.g., HAO, LAO, NO). A decision can be made as to the regime in which to classify the overall data based on, for example, into which regime a majority of the frames are classified.

Referring to FIGS. 7 and 8, the frame determination engine 130 receives live time series data and places the data in various overlapping frames. At 250 of FIG. 8, the amplitude feature computation engine 240 computes the amplitude feature by computing the difference between the maximum and minimum data amplitudes for each frame. At 252, the frequency feature computation engine 242 computes a frequency feature for a frame by converting the time series data of each frame to the frequency domain, computing the square of each spectral coefficient and identifying the largest squared spectral coefficient. At 254, the classification engine 244, based on the amplitude and frequency features, determines whether the data in the frame is characteristic of one of multiple oscillation regimes (e.g., HAO, LAO, NO).

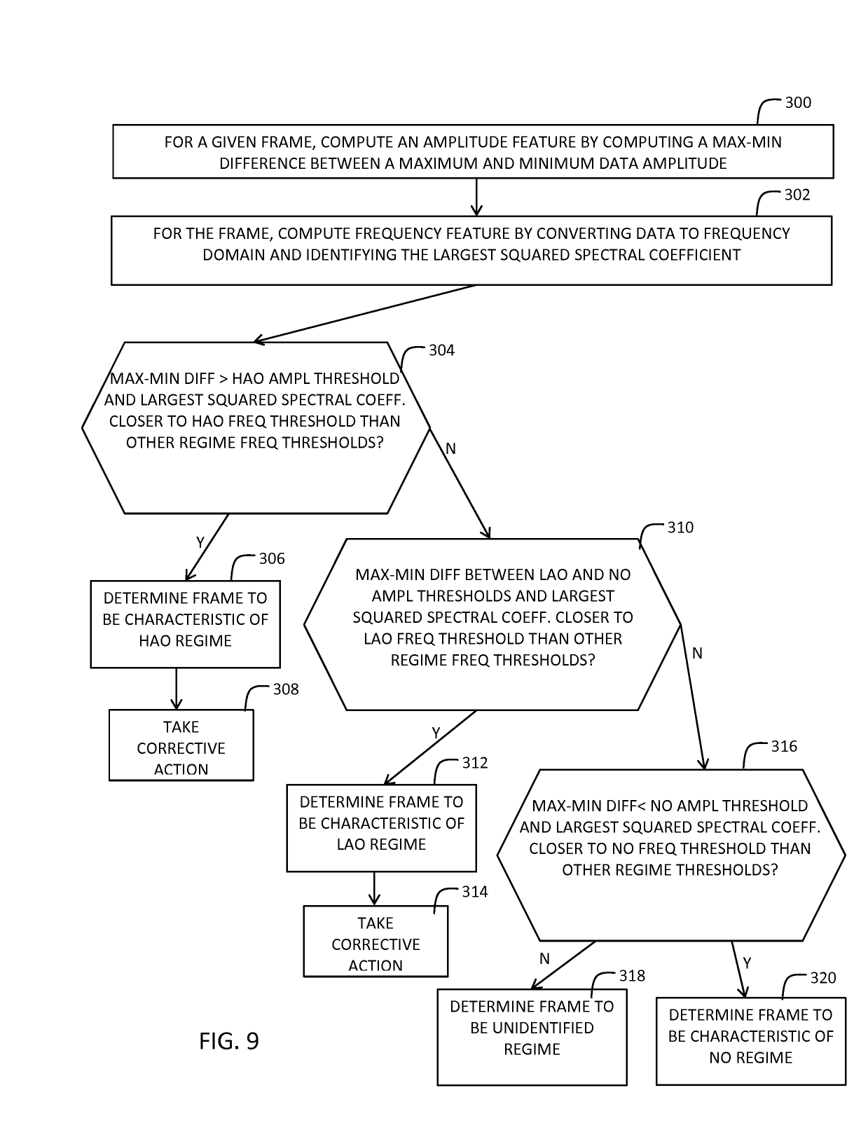

FIG. 9 illustrates the detailed process by which the classification engine classifies the time series data of a given frame. At 300, the classification engine 135 computes the amplitude feature by computing a difference between a maximum data amplitude and a minimum data amplitude (max−min amplitude difference). At 302, the frequency feature is computed for the frame by converting the time series data to the frequency domain and identifying the largest squared spectral coefficient for the frame.

At 304, the classification engine 244 determines whether the max−min amplitude difference from 300 is greater than the HAO amplitude threshold (e.g., μ_{A}-σ_{A} based on the HAO training data) and whether the largest squared spectral coefficient is closer to the HAO frequency threshold than the other regimes' frequency thresholds. If these conditions are true, then the classification engine 244 determines at 306 that the frame's data is characteristic of the HAO regime. At 308, the system 100 may take an appropriate corrective action. The corrective action depends on the nature of the data and may include generating an alert (visual, audible, text message, email, automated phone call, etc.),

If the determination in 304 is false (i.e., the frame's data is not determined to be characteristic of the HAO regime), the classification engine 244 determines whether the data is instead characteristic of the LAO regime. At 310, the classification engine 244 determines whether the max−min amplitude difference from 300 is between the LAO amplitude threshold and the NO amplitude and whether the largest squared spectral coefficient is closer to the LAO frequency threshold than the other regimes' frequency thresholds. If these conditions are true, then the classification engine 244 determines at 312 that the frame's data is characteristic of the LAO regime. At 314, the system 100 may take an appropriate corrective action. The corrective action depends on the nature of the data and may include generating an alert (visual, audible, text message, email, automated phone call, etc.),

If the determination in 310 is false (i.e., the frame's data is not determined to be characteristic of the LAO regime), the classification engine 244 determines whether the data is instead characteristic of the NO regime. At 316, the classification engine 244 determines whether the max−min amplitude difference from 300 is less than the NO amplitude and whether the largest squared spectral coefficient is closer to the NO frequency threshold than the other regimes' frequency thresholds. If these conditions are true, then the classification engine 244 determines at 320 that the frame's data is characteristic of the NO regime. If the frame's data is not characteristic of any of the regimes, then at 318, the classification engine 244 determines the data to be characteristic of an unidentified regime.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
computing, by an amplitude feature computation engine, an amplitude feature of a frame of time-series data;
computing, by a frequency feature computation engine, a frequency feature of the frame of time-series data; and
based on the computed amplitude and frequency features, determining, by a classification engine, whether the time-series data is characteristic of one of a plurality of oscillation regimes.

2. The method of claim 1 wherein computing the amplitude feature comprises computing a max−min difference between a maximum data amplitude in the frame and a minimum data amplitude in the frame.

3. The method of claim 1 wherein computing the frequency feature comprises:
converting the time-series data to a frequency domain to produce a plurality of spectral coefficients;
computing a square of each spectral coefficient to compute a plurality of squared spectral coefficients;
identifying the largest squared spectral coefficient.

4. The method of claim 1 wherein determining whether the time-series data is characteristic of one of the plurality of oscillation regimes comprises comparing the amplitude and frequency features to thresholds corresponding to each regime.

5. The method of claim 1 wherein:
computing the amplitude feature comprises computing a max−min difference between a maximum data amplitude in the frame and a minimum data amplitude in the frame;
computing the frequency feature comprises identifying a largest squared spectral coefficient; and
determining whether the time-series data is characteristic of one of the plurality of oscillation regimes comprises:
determining the time series data to be indicative of a higher amplitude oscillation regime when the max−min difference is greater than a higher amplitude oscillation (HAO) amplitude threshold and the largest squared spectral coefficient is closer to an HAO frequency threshold than to a lower amplitude oscillation (LAO) frequency threshold or a normal oscillation (NO) threshold;
determining the time series data to be indicative of a LAO regime when the max−min difference is between an LAO amplitude threshold and a NO amplitude threshold and the largest squared spectral coefficient is closer to an LAO frequency threshold than the HAO or NO frequency thresholds; and
determining the time series data to be indicative of a NO oscillation regime when the max−min difference is less than the NO amplitude threshold and the largest squared spectral coefficient is closer to the NO frequency threshold than the HAO or LAO frequency thresholds.

6. A non-transitory, computer-readable storage device containing software that, when executed by a processor causes the processor to:
compute an amplitude feature of a frame of time-series data;
compute a frequency feature of the frame of time-series data;
based on the computed amplitude and frequency features, determine whether the time-series data is characteristic of one of a plurality of oscillation regimes.

7. The non-transitory, computer-readable storage device of claim 6 wherein the software causes the processor to compute the amplitude feature by computing a max−min difference between a maximum data amplitude in the frame and a minimum data amplitude in the frame.

8. The non-transitory, computer-readable storage device of claim 7 wherein the software causes the processor to compute the amplitude feature by computing a separate amplitude feature for each of a plurality of frames of time-series data and wherein computing the max−min difference comprises computing a max−min difference between a maximum data amplitude in each frame and a minimum data amplitude in such frame.

9. The non-transitory, computer-readable storage device of claim 8 wherein the frames overlap.

10. The non-transitory, computer-readable storage device of claim 6 wherein the software causes the processor to compute the frequency feature by converting the time-series data to a frequency domain to produce a plurality of spectral coefficients.

11. The non-transitory, computer-readable storage device of claim 10 wherein the software causes the processor to compute the frequency feature by computing a square of each spectral coefficient to compute a plurality of squared spectral coefficients, and to identify the largest squared spectral coefficient.

12. The non-transitory, computer-readable storage device of claim 6 wherein the software causes the processor to determine whether the time-series data is characteristic of one of the plurality of oscillation regimes by comparing the amplitude and frequency features to thresholds corresponding to each regime.

13. The non-transitory, computer-readable storage device of claim 6 wherein the software causes the processor to divide the time-series data into overlapping frames.

14. The non-transitory, computer-readable storage device of claim 6 wherein the software causes the processor to:
compute the amplitude feature by computing a max−min difference between a maximum data amplitude in the frame and a minimum data amplitude in the frame;
compute the frequency feature comprises by identifying a largest square spectral coefficient in the frame; and
determine the time series data to be indicative of a higher amplitude oscillation regime when the max−min difference is greater than a higher amplitude oscillation (HAO) amplitude threshold and the largest squared spectral coefficient is closer to an HAO frequency threshold than to a lower amplitude oscillation (LAO) frequency threshold or a normal oscillation (NO) threshold;
determine the time series data to be indicative of a LAO regime when the max−min difference is between an LAO amplitude threshold and a NO amplitude threshold and the largest squared spectral coefficient is closer to an LAO frequency threshold than the HAO or NO frequency thresholds; and
determine the time series data to be indicative of a NO oscillation regime when the max−min difference is less than the NO amplitude threshold and the largest squared spectral coefficient is closer to the NO frequency threshold than the HAO or LAO frequency thresholds.

15. A system, comprising:
a frame determination engine to divide time-series data into a plurality of frames;
an amplitude feature computation engine to compute an amplitude feature for the time-series data in each frame;
a frequency feature computation engine to convert the time-series data in each frame to a frequency domain and to compute a frequency feature for each frame; and
a bivariate vector engine to compute a bivariate vector for the time-series data based on the amplitude and frequency features.

16. The system of claim 15 wherein the amplitude feature computation engine is to compute for each frame a max−min difference between a maximum data amplitude and a minimum data amplitude and to compute an average and a standard deviation of the max−min differences across the frames.

17. The system of claim 16 wherein the frequency feature computation engine is to compute the frequency feature for each frame by computing a plurality of spectral coefficients, squaring the spectral coefficients, identifying the largest squared coefficient, and averaging the largest identified squared coefficients across the frames.

18. The system of claim 17 wherein the bivariate vector engine computes the bivariate vector based on the average and standard deviation of the max−min differences across the frames and based on an average of the largest identified squared coefficients across the frames.

19. The system of claim 15 wherein the system also includes a clustering engine.

20. The system of claim 15 wherein a size of each frame is to be determined based on an analysis of classification results.
